(19) United States
(12) Patent Application Publication
(10) Pub. No.: US 2014/0154439 A1
(43) Pub. Date: Jun. 5, 2014

(54) METHODS FOR GLASS STRENGTHENING

(71) Applicant: Corning Incorporated, Corning, NY (US)

(72) Inventors: Steven Edward DeMartino, Painted Post, NY (US); Thomas Helmut Elmer, Corning, NY (US); Alexander Usenko, Painted Post, NY (US)

(73) Assignee: Corning Incorporated, Corning, NY (US)

(21) Appl. No.: 14/091,607

(22) Filed: Nov. 27, 2013

Related U.S. Application Data
(60) Provisional application No. 61/731,770, filed on Nov. 30, 2012.

(51) Int. Cl. C03C 23/00; C03C 21/00

(52) U.S. Cl. CPC C03C 23/008; C03C 21/006
USPC 428/34.4; 65/31; 65/30.12; 428/410

(57) ABSTRACT

Methods include providing a glass, wherein the glass is capable of being phase separated; phase separating the glass; leaching at least one surface of the glass to form a leached glass surface layer; and replenishing the leached glass surface layer with constituents to form a replenished glass surface layer, wherein the constituents cause swelling of the replenished glass surface layer.

### CROSS-REFERENCE TO RELATED APPLICATIONS

This application claims the benefit of priority under 35 U.S.C. §119 of U.S. Provisional Application Ser. No. 61/731,770 filed on Nov. 30, 2012, the entire content of which is hereby incorporated by reference.

### FIELD

This disclosure relates generally to methods for glass strengthening glass after the glass is formed to improve mechanical properties, and more particularly, to chemical processing of glass where some glass constituents are leached from near surface layer in the glass while the same layer is replenished with other constituents that cause swelling of the near surface layer.

### TECHNICAL BACKGROUND

There are three typical methods of glass strengthening: thermal tempering, ion exchange, and laminating.

Thermal tempering uses fast cooling of a heated glass. During the fast cooling, outer glass cools faster than inner glass. Cooling of the outer glass causes an increase in the glass viscosity, and a rigid outer envelope containing soft inner glass exists at this moment. Later, the inner glass also cools and shrinks inside of the fixed size envelope. Thus upon reaching thermal equilibrium the inner glass is in tensile stress. Outer glass goes under compressive stress as any unbalanced stress in a piece compensates by an opposite sign stress. The glass with inner part in tensile stress and outer part in compressive stress is more difficult to break compared to the same glass having no stresses. This is because glass breaks through creating a flaw on surface and further propagating the flaw until the breakage.

Ion exchange method is also based on the same principle where a compressively stressed envelope covers the tensile stressed inner glass. During the ion exchange process smaller radius ions in near surface glass are exchanged for higher radius ions. Eventually, the bigger ion radius ions occupy more space causing a compressive stress in the outer glass.

Laminating involves covering a glass with a layer of another glass at relatively high temperature. The laminate glass is chosen to have lower thermal expansion coefficient then the inner glass. Upon cooling, the inner glass shrinks more than the laminate, thus causing the inner glass to be under tensile stress, and laminated glass under compression. The strengthening is due to, again, the same principle—making tensile stressed inner glass in a compressively stressed envelope.

Another way of glass strengthening is laminating the glass with a soft film, i.e., film having low Young modulus, for example, polymer films. The mechanism of strengthening in this case is minimization of surface flaws. Before the coating with the polymer protective film, the surface flaws on the glass are minimized by, for example, etching, thus the surface layer with the flaws is removed. When surface of such coated article is hit, the low Young modulus film absorbs the hit energy and prevents forming of new surface flaws in the glass.

It would be advantageous to have a method of glass strengthening that would allow strengthening glass families that cannot be strengthened with conventional methods.

### SUMMARY

One embodiment is a method comprising providing a glass, wherein the glass is capable of being phase separated; phase separating the glass; leaching at least one surface of the glass to form a leached glass surface layer; and replenishing the leached glass surface layer with constituents to form a replenished glass surface layer, wherein the constituents cause swelling of the replenished glass surface layer.

The disclosed methods of strengthening glass may provide one or more of the following advantages: allow strengthening of many glass families including some glasses that are hard to strengthen using conventional techniques, are capable of strengthening complex shapes including small necked vessels such as small vials, pipettes, syringes, bottles, auto-injectables and any other glass delivery system, or are capable of producing strengthened glass or glass articles having an increased chemical durability along with mechanical durability. The methods may be cheaper as compared to ion exchange or laminating techniques, and may be cost comparable with thermal tempering. The methods may be applicable to strengthening of very thin glass articles, thinner then achievable by conventional methods.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a flow chart of an exemplary method. Process sequence for strengthening by leaching and swelling;

FIG. 2 is graph of Module of Rupture for Vycor® glass phase separated during 3 hours at 580° C. and cooled down at 100° C./hour ramp;

FIG. 3 is a graph of Module of Rupture for Vycor® glass phase separated during 3 hours at 600° C. and cooled down at 100° C./hour ramp;

FIG. 4 is a graph of Module of Rupture for Vycor® glass phase separated during 3 hours at 620° C. and cooled down at 100° C./hour ramp;

FIG. 5 is a graph of Module of Rupture for Vycor® glass phase separated during 3 hours at 640° C. and cooled down at 100° C./hour ramp; and

FIG. 6 is a graph of Module of Rupture for Vycor® glass phase separated during 3 hours at 600° C. and cooled down at 25° C./hour ramp.

### DETAILED DESCRIPTION

Reference will now be made in detail to the present preferred embodiment(s), examples of which is/are illustrated in the accompanying drawings. Whenever possible, the same reference numerals will be used throughout the drawings to refer to the same or like parts.

One embodiment is a method comprising providing a glass, wherein the glass is capable of being phase separated; phase separating the glass; leaching at least one surface of the glass to form a leached glass surface layer; and replenishing the leached glass surface layer with constituents to form a replenished glass surface layer, wherein the constituents cause swelling of the replenished glass surface layer.

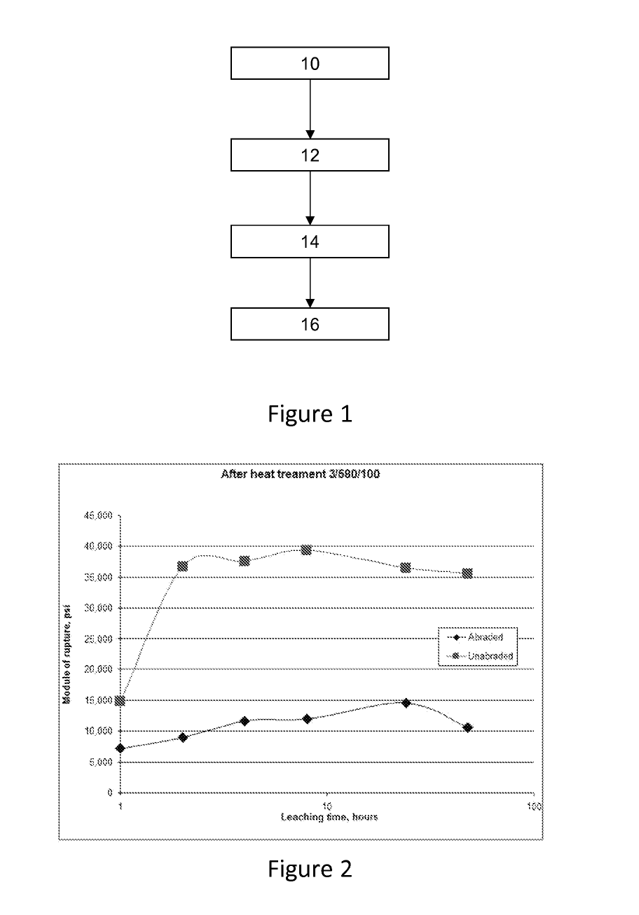

Some of the disclosed methods comprise choosing glass composition that can be phase separated 10, heat treatment so as to phase separate the glass thus make it leachable 12, leaching the glass surface layer 14, and replenishing the leached away constituents by different constituents 16, FIG. 1.

The replenishing may be performed in a way so as to cause swelling the glass surface layer. The swelled layer causes tensile stress in the inner (non-leached) glass. The resulting glass article comprises tensile inner and compressive envelope parts.

As an example, sodium borosilicate glasses can be chosen, as they undergo phase separation upon heat treatment. The composition may comprise 50-80% weight silica, 10-40% weight B₂O₃, and 5-20% weight Na₂O.

The glass article can be further processed in a heating apparatus that is at a temperature around 600° C. for a time sufficient to cause the phase separation that is typically few hours. The glass can separate by spinodal decomposition, thus forming interconnected silica enriched phase, and interconnected borate enriched phase. The formed pattern is similar to one seen in Vycor®, registered trademark of Corning Incorporated, type glasses—a wormy pattern.

Cooling down after the phase separation can be performed at low ramp rate, 100 to 25° C./hour. The slow cooling can give the glass minimal residual stresses; further processing of the non-stressed glass eventually results in glass with high mechanical strength.

Then the glass is leached, for example, in mineral acids to cause leaching to a depth in a range from 2 to 20% of the thickness of the glass article. The leached glass is porous and is comprised mainly of silica, while the borate phase is leached away. As an example, a 5 millimeter diameter glass rod can be leached to a depth about 0.2 millimeters. Medium diluted—1N to 10N nitric acid can be used for this purpose. Leaching can be performed at elevated but still convenient temperatures, say, at 95° C. in order to achieve desired leach depth in a shorter time. The etching time can be from about 1 hour to tens of hours. The partial leaching results in a few tenths of a millimeter porous layer.

After the leaching the rods are washed in boiling deionized water. Then the porous layers in the rods are replenished with constituents that cause swelling the porous layer. A way of swelling of the porous glass clad is cooling the glass in water until it reaches room temperature. In this case water is adsorbed by the porous layer and causes the swelling. Then the glass is dried in air at about 120° C. and it is ready to use.

The level of glass strengthening can be characterized by various measuring techniques, for example, by determining of module of rupture (MOR). Typically, the MOR increases 2 to 3 times by using the disclosed method. For example, a 5 mm rod made of sodium borosilicate glass has initial MOR about 138 MPa, and 345 MPa after the strengthening.

### EXAMPLES

Vycor® glass rods having 5 mm outside diameters (O.D.) were used. An exemplary glass composition is shown in Table 1. The rods were cut to four-inch lengths prior to heat treatment. The unabraded strength of the rods was about 152 MPa.

TABLE 1

| Oxide | Weight % |
|---|---|
| SiO₂ | 73 |
| Al₂O₃ | 2 |
| B₂O₃ | 15 |
| Na₂O | 4 |
| PbO | 6 |

The rods were heat treated at temperatures ranging from 580° C. to 640° C. This was done by heating the glass at a ramp rate of 100° C./hr from a starting temperature of about 400° C. to the desired hold temperature, holding three hours, cooling at 100° C./h to about 460° C., and further cooling at the natural cooling rate of the furnace with the power shut off.

The heat-treated rods were etched for twenty minutes in 10 wt. % NH₃HF at 22° C. to remove a silica-rich surface skin and to assure that leaching proceeds uniformly over the surface of the glass. The rods were then rinsed in distilled water to remove fluorides from the surface.

Leaching was carried out in 1N HNO₃ at 90° C. in glass vessels. The leaching time varied from about one to forty-eight hours. This assured a 3-to-8-fold variation in thickness of the leached layer depending on the heat treatment of the base glass. After partial leaching, the rods were washed for ten minutes in distilled water at 90° C., cooled in water at room temperature, and dried. The thickness of the resulting porous layers on the rods was measured with a microscope.

The modulus of rupture (MoR) measurements were made on partially leached rods that had been equilibrated in a room atmosphere with 50% relative humidity. The rods were mounted on a universal testing machine using double knife edges having a span length of 3.5″. The cross-head speed was 2.5 mm/min. Tests were carried out on both abraded and unabraded rods. A jar mill containing 30-grit SiC was used for abrading the surface of the rods, following a standard abrading procedure. All tests were made in air at room temperature. The MoR values in the tables represent the average three-point bending strength of ten rods.

Average MoR values obtained on partially leached glass rods prepared from 580° C., 600° C., 620° C., and 640° C. heat-treated glass are given in Table 2.

TABLE 2

| Run | | Leaching Time | | MoR |
|---|---|---|---|---|
| No. | Heat Treatment | (Hours) | MoR (abraded) | (unabraded) |
| 1, 11 | 3/580/100 | 1 | 7,210 | 14,900 |
| 2, 12 | 3/580/100 | 2 | 8,950 | 36,800 |
| 3, 13 | 3/580/100 | 4 | 11,700 | 37,600 |
| 4, 14 | 3/580/100 | 8 | 12,000 | 39,400 |
| 5, 15 | 3/580/100 | 24 | 14,600 | 36,500 |
| 6, 16 | 3/580/100 | 48 | 10,600 | 35,600 |
| 7, 10 | As drawn | — | 11,700 | 21,500 |
| 8, 9 | Heat treat only | — | 8,190 | 22,700 |
| —, 26 | 3/600/100 | 0.67 | — | 29,600 |
| 20, 27 | 3/600/100 | 1 | 8,910 | 31,200 |
| 21,28 | 3/600/100 | 2 | 12,800 | 38,700 |
| 22, 29 | 3/600/100 | 4 | 12,600 | 42,200 |
| 23, 30 | 3/600/100 | 8 | 11,200 | 39,900 |
| 24, 31 | 3/600/100 | 24 | 12,000 | 38,200 |
| 32, 33 | 3/600/100 | 48 | 10,800 | 31,200 |
| 19, 25 | Heat treat only | — | 7,760 | 22,300 |
| 42, 43 | 3/620/100 | 1 | 8,020 | 36,380 |
| 36, 39 | 3/620/100 | 2 | 10,000 | 35,630 |
| 37, 40 | 3/620/100 | 4 | 9,980 | 46,950 |
| 50, 51 | 3/620/100 | 8 | 10,760 | 46,620 |
| 38,41 | 3/620/100 | 24 | 11,600 | 36,370 |
| 52, 53 | 3/620/100 | 48 | 9,900 | 31,710 |
| 44, 45 | As drawn | — | 10,190 | 21,820 |
| 46, 47 | Heat treat only | — | 7,610 | 19,960 |
| 48, 49 | 3/640/100 | 1 | 8,530 | 35,280 |
| 54, 55 | 3/640/100 | 2 | 8,330 | 37,200 |
| 58, 59 | 3/640/100 | 4 | 7,910 | 43,380 |
| 60, 61 | 3/640/100 | 8 | 10,340 | 43,870 |
| 62, 53 | 3/640/100 | 24 | 11,490 | 37,660 |
| 56, 57 | Heat treat only | — | 7,600 | 22,800 |
| 64, 65 | 3/600/25 | 1 | 11,400 | 40,820 |
| 68, 69 | 3/600/25 | 2 | 12,900 | 41,330 |
| 66, 67 | 3/600/25 | 4 | 14,230 | 47,430 |
| 70, 71 | 3/600/25 | 8 | 14,060 | 39,050 |
| 72, 73 | 3/600/25 | 24 | 12,340 | 32,630 |
| 74, 75 | Heat treat only | — | 7,710 | 25,440 |

It should be noted that tumble abrading the rods can lower strength. For example, samples, from run 29 and 22 have an average MoR of 42,200 and 12,600 psi before and after abrasion treatment, indicating a greater than three-fold decrease in strength. However, despite such a loss in strength, the abraded, partially leached rods are still stronger than the parent glass which decreases from about 22,000 to <8,000 psi on abrasion treatment.

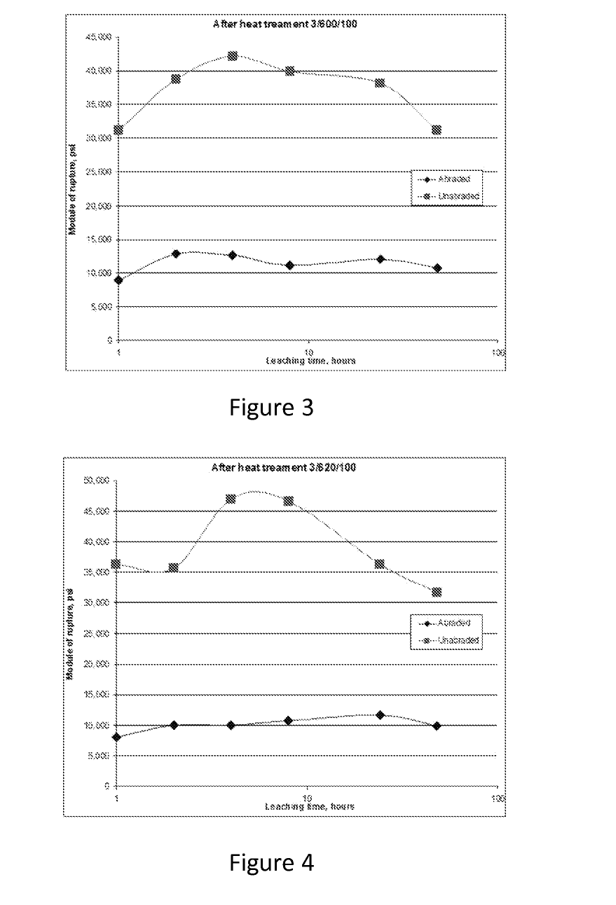

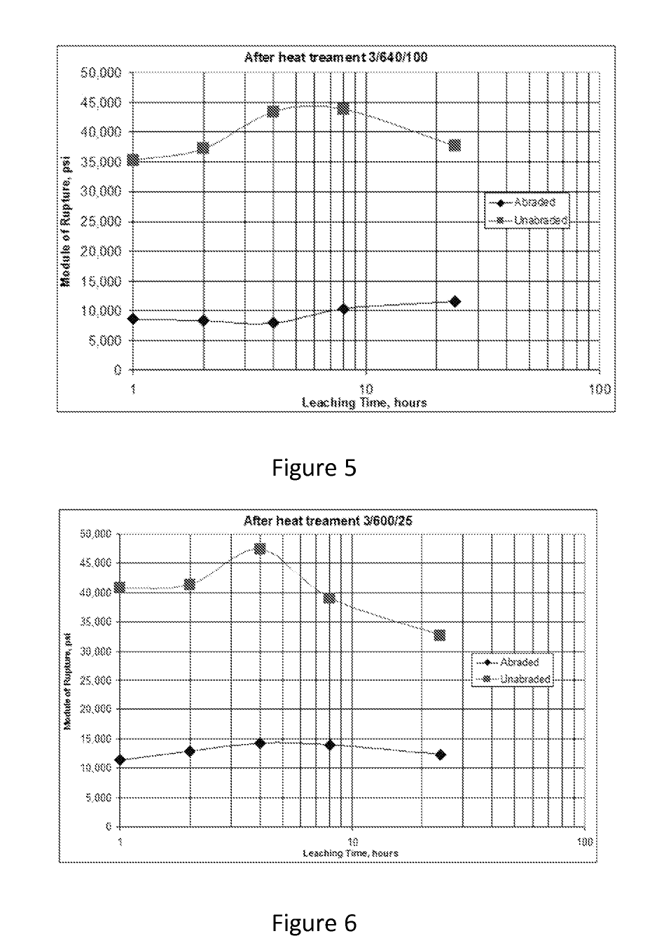

The strength of the partially leached rod is a function of both heat treatment and leaching time. This is illustrated in FIGS. 2-6 which were prepared from the data in Table 1. FIG. 2 is a graph of Module of Rupture for Vycor® glass phase separated during 3 hours at 580° C. and cooled down at 100° C./hour ramp. FIG. 3 is a graph of Module of Rupture for Vycor® glass phase separated during 3 hours at 600° C. and cooled down at 100° C./hour ramp. FIG. 4 is a graph of Module of Rupture for Vycor® glass phase separated during 3 hours at 620° C. and cooled down at 100° C./hour ramp. FIG. 5 is a graph of Module of Rupture for Vycor® glass phase separated during 3 hours at 640° C. and cooled down at 100° C./hour ramp. FIG. 6 is a graph of Module of Rupture for Vycor® glass phase separated during 3 hours at 600° C. and cooled down at 25° C./hour ramp.

The maxima in the curves for unabraded and abraded rods do not necessarily coincide, as might be expected. This could be due to variation in strength-controlling flaws that are introduced during handling and processing of the specimens. The maximum unabraded and abraded strength were 47,430 and 14,600 psi, respectively. It should be noted that decreasing the cooling rate from 100 to 25° C./h, increases the strength of the partially leached rods.

Photoelastic measurements of partially leached glass show that the porous-surface layer is in compression and the core glass in tension. The adsorption of water by the porous glass is chiefly responsible for these stresses because such adsorption is accompanied by a large extension of the porous high-silica skeleton. The stresses are a function of the amount of water adsorbed by the porous glass layer. This is illustrated by using not only distilled water but also alcohol as sorbent. The thickness of the porous layer that is calculated from the stress optical data is in good agreement with those actually measured with a microscope. The tensile stresses in the core, calculated from the retardation values are below the minimum long-time breaking stress of 13 MPa.

The porous surface layer acts as protective coating, minimizing the role surface flaws that are generally responsible for breakage of glass subjected to tension. Since adsorption of water by porous glass is accompanied by a large extension of the porous skeleton, one would expect that the integral porous surface layer on partially leached rods would be in compression. This would account for the strengthening that has been observed on partially leached rods.

The glass plates used in some examples were prepared from Vycor® glass cane. The dimensions of the plates were as follows: ˜3 cm long, ˜4 cm wide, and 2 mm thick. Prior to their preparation, the cane had been heat treated for three hours at 600° C. and cooled at 25° C./h to about 450° C. The plates were leached for 1, 2, 5, and 6 hours in 1N HNO₃, and washed for ten minutes in distilled water, all at 95° C. The porous surface layers were 53, 118 and 250 microns in thickness, as measured with a microscope.

The stress in the core and porous layer of the plates was measured by means of a polarizing microscope and optical compensator. The samples were equilibrated in room air having a relative humidity of 56% prior to making the photoelastic measurements. Additional measurements were made with the plates immersed in distilled water or alcohol, taking readings of the change in retardation in the core as a function of immersion time in these fluids.

The retardation in degrees was observed in the core and the porous surface layer during the photoelastic measurements. The porous layer was in compression, whereas the core was in tension. Table 3 summarizes the stress values that were calculated from the retardation figures. It should be noted that the tensile stress in the core for Sample 3 is below the minimum long-time breaking stress of 1920 lb/in². The compressive stress in the porous surface layer decreases with thickness from about 4800 to 3600 psi.

TABLE 3

| | Compressive | | Depth of | Depth of Layer |
|---|---|---|---|---|
| | Stress (CS) | Tension | Layer (DOL), | (DOL), measured |
| | in surface | in glass | calculated, | by microscope, |
| Sample | layer, MPa | bulk, MPa | microns | microns |
| 1 | 33.2 | 2.08 | 53 | 56 |
| 2 | 24.8 | 3.67 | 118 | 121 |
| 3 | 26.5 | 7.14 | 250 | 205 |

TABLE 4

| Time, | | Tensile stress, | |
|---|---|---|---|
| minutes | Retardation, degrees | MPa | remarks |
| 0 | 19 | 3.67 | Specimen equilibrated in |
| | | | room air at 56% relative |
| | | | humidity |
| 0.6 | 31 | 5.98 | |
| 1.0 | 37 | 7.14 | |
| 1.25 | 41 | 7.91 | |
| 2.0 | 45 | 8.68 | |
| 2.7 | 47 | 9.07 | Porous layer completely |
| 4.0 | 47 | 9.07 | filled with water |
| 5.0 | 47 | 9.07 | |

The stress in the core and porous layer of the plates was measured by means of a polarizing microscope and optical compensator. The samples were equilibrated in room air having a relative humidity of 56% prior to making the photoelastic measurements. Additional measurements were made with the plates immersed in distilled water or alcohol, taking readings of the change in retardation in the core as a function of immersion time in these fluids.

The data in Table 4 indicates that the retardation increases gradually as the porous surface layer absorbs water. It reaches a finite value when the pores are completely filled with water. The tensile stresses in the core calculated from the retardation values increases from 3.67 to 9.07 MPa during the wetting process. Measurements of the porous surface layer after soaking in water indicated that it is in compression. The calculated compressive stress is 6030 lb/in², based on a stress-optical coefficient of 0.277 nm/cm/psi. Similar results were obtained when the above specimen was immersed in ethyl alcohol. The final tensile stress in the core is upon immersion in ethyl alcohol is 1429 Ib/in². This is about 100 Ib/in² higher than when water was used as absorbant in the porous surface layer. Stress optical measurements of the specimen indicated that the porous layer is in compression, as was the case when water was used as an absorbant.

The expansion of the surface is due to capillary condensation of water molecules on oxygen or silicon sites. In the case of methyl alcohol there may be a disruption of the original hydrogen bonds between adjacent OH groups in porous glass that also contributes to an expansion. This may account for the fact that ethyl alcohol, which also possesses an OH groups, produced a somewhat higher tensile stress in the core than water. Specimens soaked in water or alcohol had tensile stresses of 1326 and 1428 Ib/in².

The disclosed methods can also be considered an ion exchange process. However, in the disclosed methods, boron is exchanged for water, while in the prior art process, one alkali ion is typically exchanged for another alkali ion.

The stresses observed in the air-dried specimens, are partly due to adsorption of water molecules from the atmosphere. The water causes the porous glass to expand and induces a tensile stress in the core that constrains the porous surface layer. This stress, in turn, is compensated by an equivalent compressive stress in the porous layer. The magnitude of these two opposing stresses depends on the amount of water in the pores, reaching finite values when the pores are completely filled. Since alcohol plays a similar role, it is concluded that other liquids will also induce stresses in partially leached glass specimens.

Young modulus was measured in the surface layer and in the glass bulk. The modulus of elasticity of the porous glass that comprises the porous surface layer is about one half that of the unleached glass. Since the porous surface layer is in compression and, furthermore, has a lower Young's modulus than unleached glass, it can undergo a larger dimensional change when subjected to a given stress than the body glass. Hence, it is not surprising that the partially leached rods are stronger than untreated rods.

Photoelastic measurements show that the core glass of partially leached Vycor® glass plates is in tension, whereas the porous surface layer is in compression. This is due to the fact that the adsorption of water by porous glass is accompanied by a large extension of the silica-rich skeleton. It induces a tensile stress in the core which constrains the porous surface layer that must be compensated by a compressive stress in the porous layer. The magnitude of these two opposing stresses depends on the amount of water in the pores, reaching a finite value when they are completely filled. The effect of alcohol was found to be similar to that of water. The tensile stress in the core of partially leached specimens is well below the minimum breaking stress of 1920 lb/in² that is based on practical experience on commercial glasses.

The strength of Vycor® glass rods is dramatically increased by partial leaching in hot acid, such as 1N HNO₃ at 95° C. For a given heat treatment, strength depends on the leaching time which determines the thickness of the porous layer that clads the parent glass. Strength generally goes through a maximum with leaching time. Slower cooling rates of the parent glass from the hold temperature are beneficial as regards final strength of such composite glass articles. The porous cladding on Vycor® glass is appreciably weakened by tumble abrading with 30-grit SiC. However, the strength is still about twice that of abraded parent glass. The highest abraded and unabraded strength of the partially leached specimens was 47,430 and 14,230 psi, respectively.

Other, than diluted nitric acid leachants can be successfully used for the strengthening, for example, leaching in diluted ammonium bifluoride in optimized conditions results in MoR values 60,000 to 70,000 psi for the similar unabraded rods.

Module or rupture measurements described above are an exemplary way to illustrate the glass strengthening using the methods described herein. The strengthening can be also illustrated by ball drop, ring-on-ring, pencil hardness, or other standard mechanical testing techniques.

Other alkali-boro-silicate glasses behave very similar to the described above strengthening of the Vycor® glass. Their mechanical strength is improved by chemical removal alkali-borate enriched phase to a certain depth and subsequent swelling of the porous layer through adsorption of hydroxyls from water. Many glasses outside of the alkali-boro-silicate system can be strengthened using the methods described herein.

It will be apparent to those skilled in the art that various modifications and variations can be made without departing from the spirit or scope of the invention.

What is claimed is:

1. A method comprising:
providing a glass, wherein the glass is capable of being phase separated;
phase separating the glass;
leaching at least one surface of the glass to form a leached glass surface layer; and
replenishing the leached glass surface layer with constituents to form a replenished glass surface layer, wherein the constituents cause swelling of the replenished glass surface layer.

2. The method according to claim 1, wherein the glass is comprised of a sodium borosilicate glass.

3. The method according to claim 1, wherein the glass comprises in weight percent: 50-80% weight silica; 10-40% weight B₂O₃; and 5-20% weight Na₂O.

4. The method according to claim 1, wherein the leaching and replenishing comprises exchanging water for boron.

5. The method according to claim 1, wherein the leaching and replenishing comprises exchanging alcohol for boron.

6. The method according to claim 1, wherein the constituents are hydroxyl groups.

7. The method according to claim 1, wherein the replenishing causes swelling the leached glass surface layer such that there is tensile stress in the non-leached glass and compressive stress in the replenished glass surface layer.

8. A glass article strengthened according to the method of claim 1.

9. The article according to claim 8, wherein the article comprises a small necked vessel, a vial, a pipette, a syringe, a bottle, an auto-injectables vessel, or a glass delivery system.
